(19) United States
(12) Patent Application Publication
(10) Pub. No.: US 2018/0180804 A1
(43) Pub. Date: Jun. 28, 2018

(54) OPTICAL WAVEGUIDE

(71) Applicant: SHINKO ELECTRIC INDUSTRIES CO., LTD., Nagano (JP)

(72) Inventor: Kenji YANAGISAWA, Nagano (JP)

(21) Appl. No.: 15/817,687

(22) Filed: Nov. 20, 2017

(30) Foreign Application Priority Data
Dec. 26, 2016 (JP) 2016-251600

(51) Int. Cl. G02B 6/122

(52) U.S. Cl. CPC G02B 6/122; G02B 2006/12097

(57) ABSTRACT

An optical waveguide includes a substrate, a first clad layer, a core layer, and a second clad layer that are successively stacked. A first protection part formed on the substrate covers a side surface of the first clad layer, and a second protection part formed on the first clad layer covers a side surface of the second clad layer. The second clad layer is smaller than the first clad layer in a plan view of the optical waveguide. The first protection part widens from a top surface towards a bottom surface of the first clad layer, and the second protection part widens from a top surface towards a bottom surface of the second clad layer.

### CROSS-REFERENCE TO RELATED APPLICATION

This application is based upon and claims the benefit of priority of the prior Japanese Patent Application No. 2016-251600, filed on Dec. 26, 2016, the entire contents of which are incorporated herein by reference.

### FIELD

Certain aspects of the embodiments discussed herein are related to optical waveguides.

### BACKGROUND

A known optical waveguide includes a core layer sandwiched between a first clad layer and a second clad layer. In a plan view of such an optical waveguide, the second clad layer may have a size smaller than that of the first clad layer. In this optical waveguide, side surfaces of the first clad layer and the second clad layer are approximately perpendicular to each other.

Related art includes Japanese Laid-Open Patent Publication No. 2006-72352.

However, when the side surfaces of the first clad layer and the second clad layer are approximately perpendicular to each other, stress may be applied to a step part foamed between the side surface of the first clad layer and another layer. Similarly, stress may be applied to a step part formed between the side surface of the second clad layer and another layer. Such stress may cause damage, separation, peeling, or the like at end parts of the first clad layer and the second clad layer.

### SUMMARY

Accordingly, it is an object in one aspect of the embodiments to provide an optical waveguide that can reduce damage, separation, peeling, or the like at an end part of a clad layer.

According to one aspect of the embodiments, an optical waveguide including a substrate; a first clad layer formed on a top surface of the substrate; a core layer formed on a top surface of the first clad layer; a second clad layer formed on the top surface of the first clad layer and covering the core layer; a first protection part formed on the top surface of the substrate and covering a side surface of the first clad layer; and a second protection part formed on the top surface of the first clad layer and covering a side surface of the second clad layer, wherein the second clad layer has a size smaller than that of the first clad layer in a plan view of the optical waveguide viewed in a direction perpendicular to the top surface of the substrate, wherein the first protection part widens from the top surface of the first clad layer towards a bottom surface of the first clad layer, and wherein the second protection part widens from a top surface of the second clad layer towards a bottom surface of the second clad layer.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF DRAWINGS

FIGS. 1A and 1B are diagrams illustrating an example of an optical waveguide in one embodiment;

FIGS. 2A and 2B are cross sectional views illustrating modifications of shapes of a protection part; and

FIGS. 3A, 3B, 3C, 3D, 3E, and 3F are diagrams for explaining examples of manufacturing processes of the optical waveguide in one embodiment.

### DESCRIPTION OF EMBODIMENTS

Preferred embodiments of the present invention will be described with reference to the accompanying drawings. In the drawings, those parts that are the same are designated by the same reference numerals, and a repeated description of the same parts may be omitted.

A description will now be given of the optical waveguide in each embodiment according to the present invention.

[Structure of Optical Waveguide]

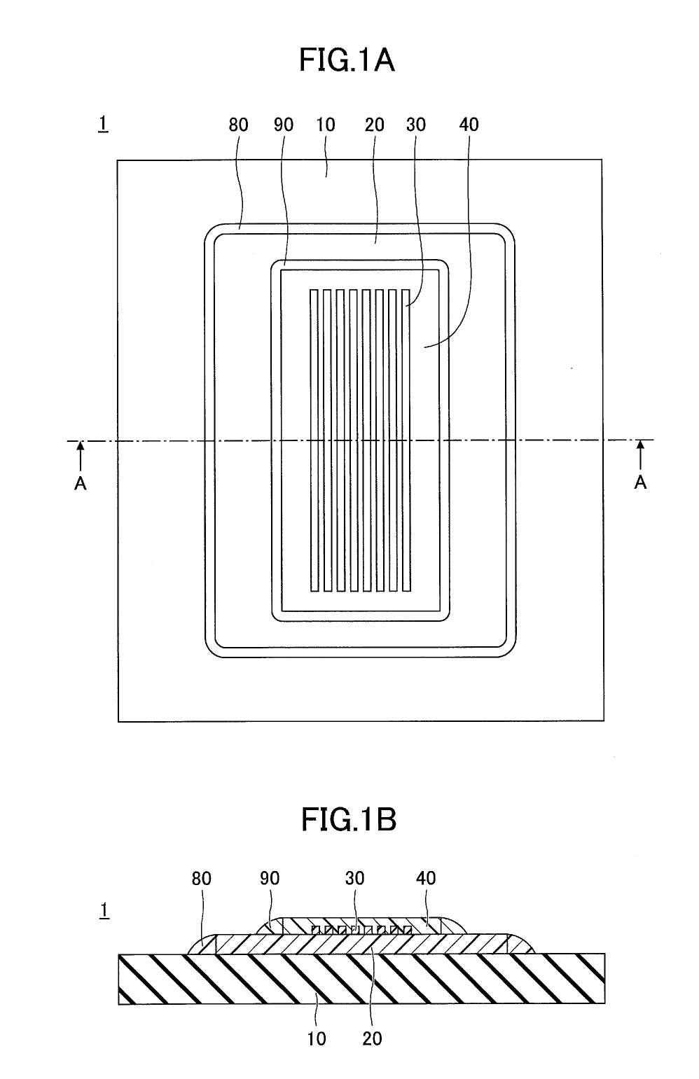

FIGS. 1A and 1B are diagrams illustrating an example of the optical waveguide in one embodiment. FIG. 1A illustrates a plan view of the optical waveguide, and FIG. 1B illustrates a cross sectional view along a line A-A in FIG. 1A. As illustrated in FIGS. 1A and 1B, an optical waveguide 1 includes a substrate 10, a first clad layer 20, a core layer 30, and a second clad layer 40.

The substrate 10 forms a base on which the first clad layer 20, the core layer 30, and the second clad layer 40 are formed. The substrate 10 is not limited to a particular type of substrate. For example, the substrate 10 may be formed by a build-up substrate having a resin layer, a silicon substrate, a ceramic substrate, or the like. The substrate 10 may include one or more electronic circuits.

The first clad layer 20 is formed on a top surface of the substrate 10. The first clad layer 20 may have a thickness in a range of approximately 10 μm to approximately 60 μm, for example. The first clad layer 20 may have a refractive index of approximately 1.5, for example. The first clad layer 20 may be made of a material selected from a group of materials including ultraviolet-curing resins, for example. The ultraviolet-curing resins include polyimide resins, acrylic resins, epoxy resins, polyolefin resins, polynorbornene resins, or the like.

The core layer 30 is formed on a top surface of the first clad layer 20. The core layer 30 may have a thickness in a range of approximately 10 μm to approximately 60 μm, for example. The core layer 30 may have a refractive index of approximately 1.6, for example. The refractive index of the core layer 30 is higher than the refractive index of each of the first clad layer 20 and the second clad layer 40. The core layer 30 may be made of a suitable material selected from the group of materials described above that may form the first clad layer 20.

In this example of the optical waveguide 1, the core layer 30 includes 8 core segments arranged in parallel at predetermined intervals. However, the number of core segments forming the core layer 30 is not limited to 8, and the core layer 30 may include an arbitrary number of core segments, that is, 1 or more core segments. In addition, the core segments of the core layer 30 do not necessarily have to be arranged linearly, and the core segments may include curved portions.

The second clad layer 40 is formed on the top surface of the first clad layer 20, to cover the core layer 30. The second clad layer 40 may have a thickness in a range of approximately 10 μm to approximately 60 μm, for example. The second clad layer 40 may have a refractive index of approximately 1.5, for example. The second clad layer 40 may be made of a suitable material selected from the group of materials described above that may form the first clad layer 20.

The second clad layer 40 has a size smaller than that of the first clad layer 20 in a plan view of the optical waveguide 1 viewed in a direction perpendicular to the top surface of the substrate 10. The smaller size of the second clad layer 40 facilitates alignment of the second clad layer 40 when forming the second clad layer 40 on the top surface of the first clad layer 20. The size of the first clad layer 20 refers to an area of the first clad layer 20 in the plan view of the optical waveguide 1. Similarly, the size of the second clad layer 40 refers to an area of the second clad layer 40 in the plan view of the optical waveguide 1.

The first clad layer 20 and the second clad layer 40 may have the same thickness or mutually different thicknesses. In addition, the first clad layer 20 and the second clad layer 40 may be made of the same material or mutually different materials.

A first protection part 80 is formed on the top surface of the substrate 10 and covers a side surface of the first clad layer 20. The first protection part 80 may be provided in a ring-shape to completely cover the side surface of the first clad layer 20, that is, to cover the entire side surface of the first clad layer 20. The first protection part 80 is preferably made of a material that is the same as the material forming the first clad layer 20. It is preferable to use the same material for the first protection part 80 and the first clad layer 20, because physical properties (for example, thermal expansion coefficients or the like) of the first protection part 80 and the first clad layer 20 will become the same, and stress will unlikely be generated at an interface between the first protection part 80 and the first clad layer 20.

The first protection part 80 has a shape that widens from the top surface of the first clad layer 20 towards a bottom surface of the first clad layer 20. The first protection part 80 may be formed to have a cross sectional shape with an arcuate side (or segment) in the cross section taken in a thickness direction perpendicular to the top surface of the substrate 10.

A second protection part 90 is formed on the top surface of the first clad layer 20 and covers a side surface of the second clad layer 40. The second protection part 90 may be provided in a ring-shape to completely cover the side surface of the second clad layer 40, that is, to cover the entire side surface of the second clad layer 40. The second protection part 90 is preferably made of a material that is the same as the material forming the second clad layer 40. It is preferable to use the same material for the second protection part 90 and the second clad layer 40, because physical properties (for example, thermal expansion coefficients or the like) of the second protection part 90 and the second clad layer 40 will become the same, and stress will unlikely be generated at an interface between the second protection part 90 and the second clad layer 40.

The second protection part 90 has a shape that widens from the top surface of the second clad layer 40 towards a bottom surface of the second clad layer 40. The second protection part 90 may be famed to have a cross sectional shape with an arcuate side (or segment) in the cross section taken in the thickness direction perpendicular to the top surface of the substrate 10.

The arcuate side (or segment) in each of the cross sectional shape of the first protection part 80 and the second protection part 90 in the cross section taken in the thickness direction is a curved convex (or outwardly curved segment).

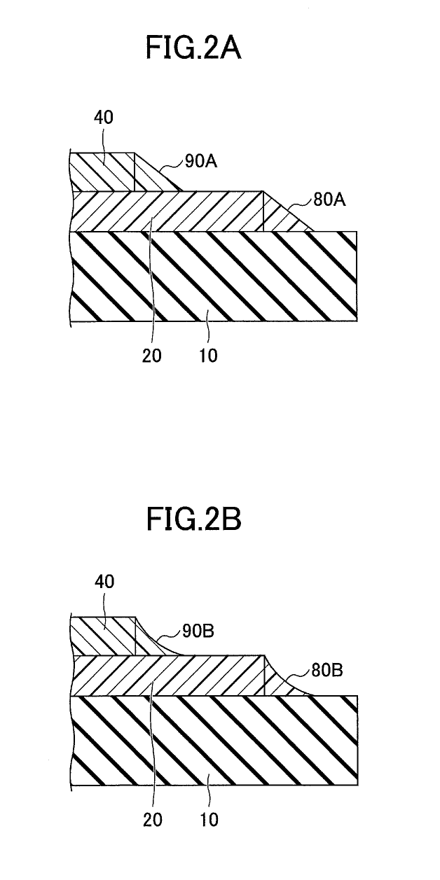

FIGS. 2A and 2B are cross sectional views illustrating modifications of shapes of a protection part. Each protection part may have the cross sectional shape with a linearly inclined side (or segment) in the cross section taken in the thickness direction perpendicular to the top surface of the substrate 10, as in the case of a first protection part 80A and a second protection part 90A illustrated in FIG. 2A. Alternatively, each protection part may have the cross sectional shape with an arcuate side (or segment) in the cross section taken in the thickness direction perpendicular to the top surface of the substrate 10, as in the case of a first protection part 80B and a second protection part 90B illustrated in FIG. 2B. The arcuate side (or segment) in each of the cross sectional shape of the first protection part 80B and the second protection part 90B in the cross section taken in the thickness direction is a curved concave (or inwardly curved segment).

[Method of Manufacturing Optical Waveguide]

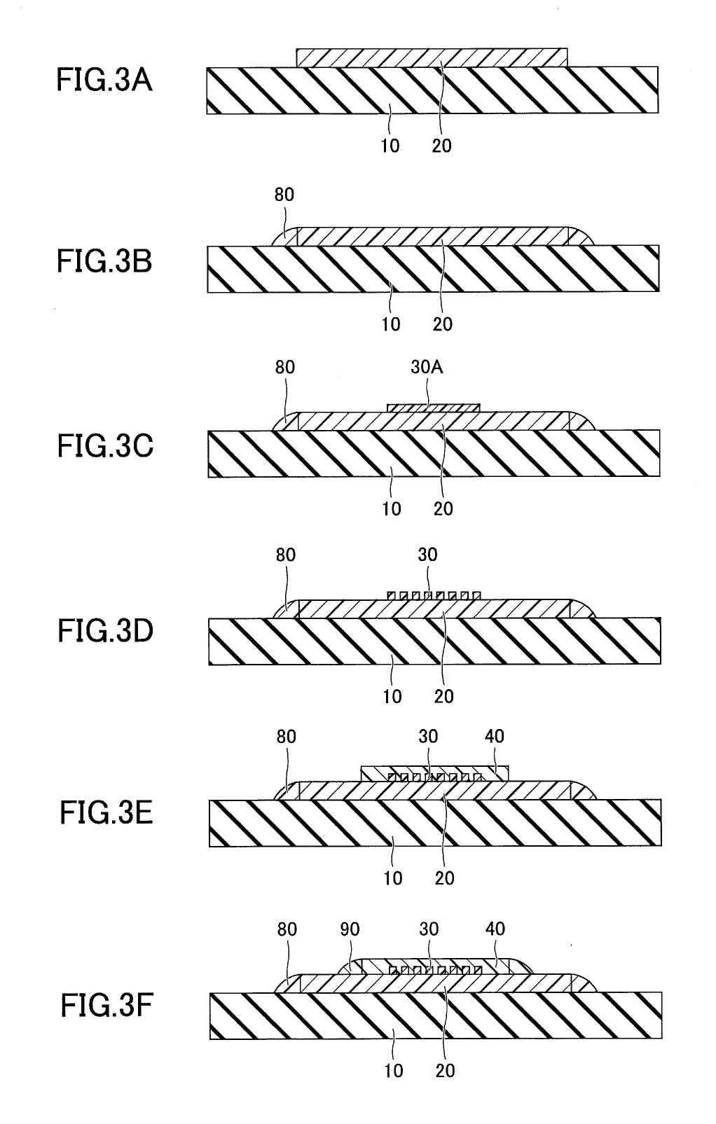

FIGS. 3A, 3B, 3C, 3D, 3E, and 3F are diagrams for explaining examples of manufacturing processes of the optical waveguide in one embodiment.

First, in the process illustrated in FIG. 3A, the substrate 10 is prepared, and the first clad layer 20 is formed on the top surface of the substrate 10. The first clad layer 20 may be formed by coating a liquid resin on the top surface of the substrate 10, and thereafter irradiating ultraviolet light on the liquid resin to cure the liquid resin, for example. In addition, the first clad layer 20 may be formed by laminating a resin film on the top surface of the substrate 10, and thereafter irradiating ultraviolet light on the resin film to cure the resin film, for example. The material used for the first clad layer 20 and the thickness of the first clad layer 20 may be the same as those described above.

Next, in the process illustrated in FIG. 3B, the first protection part 80 is formed to cover the side surface of the first clad layer 20. The first protection part 80 may be formed by coating a liquid resin on the top surface of the substrate 10 to cover the entire side surface of the first clad layer 20, and thereafter irradiating ultraviolet light on the liquid resin to cure the liquid resin, for example. The first protection part 80 is famed to a shape that widens from the top surface of the first clad layer 20 towards a bottom surface of the first clad layer 20. By suitably adjusting a viscosity of the liquid resin, a temperature during the coating of the liquid resin, and wettability (or wetting properties) of portions coated by the liquid resin, it is possible to form the first protection part 80 to the shape illustrated in any of FIGS. 1A, 2A, and 2B. For the reasons described above, it is preferable to use the same material for the first protection part 80 and the first clad layer 20.

After the process illustrated in FIG. 3B ends, the side surface of the first clad layer 20 is protected by the first protection part 80. Hence, it is possible to reduce damage, separation, peeling, or the like at an end part of the first clad layer 20 at a time when a subsequent process is performed, when mounting a component on the substrate 10 of the completed optical waveguide 1, or the like.

Next, in the process illustrated in FIG. 3C, a photosensitive resin layer 30A is formed on the top surface of the first clad layer 20. The photosensitive resin layer 30A is patterned to form the core layer 30, as will be described later. The photosensitive resin layer 30A may be formed by coating or laminating a photosensitive resin on the top surface of the first clad layer 20.

Next, in the process illustrated in FIG. 3D, the core layer 30 is formed on the top surface of the first clad layer 20. The core layer 30 may be formed by patterning the photosensitive resin layer 30A by employing photolithography and etching techniques. The material used for the core layer 30 and the thickness of the core layer 30 may be the same as those described above.

Next, in the process illustrated in FIG. 3E, the second clad layer 40 is formed on the top surface of the first clad layer 20 to cover the core layer 30. The second clad layer 40 may be formed by a method that is similar to the method used to form the first clad layer 20. The material used for the second clad layer 40 and the thickness of the second clad layer 40 may be the same as those described above.

Next, in the process illustrated in FIG. 3F, the second protection part 90 is formed to cover the side surface of the second clad layer 40. The second protection part 90 may be formed by coating a liquid resin on the top surface of the first clad layer 20 to cover the entire side surface of the second clad layer 40, and thereafter irradiating ultraviolet light on the liquid resin to cure the liquid resin, for example. The second protection part 90 is formed to a shape that widens from the top surface of the second clad layer 40 towards a bottom surface of the second clad layer 40. By suitably adjusting a viscosity of the liquid resin, a temperature during the coating of the liquid resin, and wettability (or wetting properties) of portions coated by the liquid resin, it is possible to form the second protection part 90 to the shape illustrated in any of FIGS. 1A, 2A, and 2B. For the reasons described above, it is preferable to use the same material for the second protection part 90 and the second clad layer 40.

After the process illustrated in FIG. 3F ends, the side surface of the second clad layer 40 is protected by the second protection part 90. Hence, it is possible to reduce damage, separation, peeling, or the like at an end part of the second clad layer 40 at a time when a subsequent process is performed, when mounting a component on the substrate 10 of the completed optical waveguide 1, or the like. The subsequent process performed after the process illustrated in FIG. 3F may include a cleaning process or the like that is performed on the optical waveguide 1 if required.

Accordingly, the optical waveguide 1 in this example includes the first protection part 80 that covers the side surface of the first clad layer 20, and the second protection part 90 that covers the side surface of the second clad layer 40. In addition, the first protection part 80 is formed to the shape that widens from the top surface of the first clad layer 20 towards the bottom surface of the first, clad layer 20, and the second protection part 90 is formed to the shape that widens from the top surface of the second clad layer 40 towards the bottom surface of the second clad layer 40.

Because each of the clad layers includes the protection part having the shape described above, it is possible to reduce damage, separation, peeling, or the like at the end part of each of the clad layers. In other words, the end parts of the first and second clad layers 20 and 40 are protected by the first and second protection parts 80 and 90, respectively. Particularly in a case in which each of the first and second protection parts 80 and 90 has the cross sectional shape with the arcuate side (or segment) that is the curved convex in the cross section taken in the thickness direction perpendicular to the top surface of the substrate 10, it is possible to enhance the effects of reducing the damage, the separation, the peeling, or the like at the end part of each of the first and second clad layers 20 and 40.

The provision of each of the first and second protection parts 80 and 90 is effective to reduce the damage or the like to the end part of each of the first and second clad layers 20 and 40, in a case in which a cleaning process, such as a shot blasting and wiping, is performed after the optical waveguide 1 is completed. Of course, the effect of reducing the damage or the like to the end part of each of the first and second clad layers 20 and 40 is not only achievable during the manufacturing process of the optical waveguide 1, but also when mounting the component on the substrate 10 of the completed optical waveguide 1.

In addition, in the case in which the first protection part 80 and the first clad layer 20 are made of the same material, the physical properties of the first protection part 80 and the first clad layer 20 become the same. Further, in the case in which the second protection part 90 and the second clad layer 40 are made of the same material, the physical properties of the second protection part 90 and the second clad layer 40 become the same. In these cases, stress will unlikely be generated at the interface between the protection part and the corresponding clad layer.

According to each of the embodiment and modifications described above, it is possible to provide an optical waveguide that can reduce damage, separation, peeling, or the like at an end part of a clad layer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical waveguide comprising:
a substrate;
a first clad layer formed on a top surface of the substrate;
a core layer formed on a top surface of the first clad layer;
a second clad layer formed on the top surface of the first clad layer and covering the core layer;
a first protection part formed on the top surface of the substrate and covering a side surface of the first clad layer; and
a second protection part formed on the top surface of the first clad layer and covering a side surface of the second clad layer,
wherein the second clad layer has a size smaller than that of the first clad layer in a plan view of the optical waveguide viewed in a direction perpendicular to the top surface of the substrate,
wherein the first protection part widens from the top surface of the first clad layer towards a bottom surface of the first clad layer, and
wherein the second protection part widens from a top surface of the second clad layer towards a bottom surface of the second clad layer.

2. The optical waveguide according to claim 1, wherein
the first protection part is made of a material identical to that forming the first clad layer, and
the second protection part is made of a material identical to that forming the second clad layer.

3. The optical waveguide according to claim 1, wherein each of the first protection part and the second protection part has a cross sectional shape with an arcuate side in a cross section taken in a thickness direction perpendicular to the top surface of the substrate.

4. The optical waveguide according to claim 1, wherein the first protection part completely covers the side surface of the first clad layer.

5. The optical waveguide according to claim 1, wherein the second protection part completely covers the side surface of the second clad layer.

6. The optical waveguide according to claim 2, wherein each of the first protection part and the second protection part has a cross sectional shape with an arcuate side in a cross section taken in a thickness direction perpendicular to the top surface of the substrate.

7. The optical waveguide according to claim 2, wherein the first protection part completely covers the side surface of the first clad layer.

8. The optical waveguide according to claim 2, wherein the second protection part completely covers the side surface of the second clad layer.

9. The optical waveguide according to claim 3, wherein the first protection part completely covers the side surface of the first clad layer.

10. The optical waveguide according to claim 3, wherein the second protection part completely covers the side surface of the second clad layer.

11. The optical waveguide according to claim 4, wherein the second protection part completely covers the side surface of the second clad layer.
